(19) United States
(12) Patent Application Publication
(10) Pub. No.: US 2007/0177228 A1
(43) Pub. Date: Aug. 2, 2007

(54) Method and apparatus for automatic image sensor alignment adjustment

(75) Inventors: Timothy W. Crockett, Raleigh, NC (US); Richard H. Harris, Raleigh, NC (US)

Correspondence Address: CANTOR COLBURN LLP - IBM RESEARCH TRIANGLE PARK, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/341,037

(22) Filed: Jan. 27, 2006

(51) Int. Cl. H04N 1/46

(52) U.S. Cl. 358/504; 358/448

(57) ABSTRACT

A method for dynamically adjusting alignment of a scanned image includes generating a raw scanned calibration image, processing the raw scanned calibration image so as to determine a correction for each horizontal pixel of the image, and applying the determined correction to the entire scanned image so as to produce an aligned image.

### BACKGROUND

The present invention relates generally to scanning and printing devices, and, more particularly, to a method and apparatus for dynamic, automatic image sensor alignment adjustment.

Modem point of sale (POS) printers have increasingly more and more finctionality incorporated therein, in addition to the simple printing of receipts and forms. For instance, many POS printers are presently configured to read the magnetic ink on a check and print out a copy of the check. Thus, certain printers are now incorporating image capture functionality. In such devices, it is desirable for the image sensing device in the printer to be positioned such that it is aligned squarely with the document feed path in order to minimize the occurrence of a stair-stepped image of a horizontal, straight line. As a practical matter, however, an image sensing device can be slightly misaligned with respect to a document feed path and/or the document itself can be fed in to the machine at a slightly skewed angle.

Unfortunately, existing correction methodologies that utilize a mechanical adjustment of some type result in additional parts incorporated into the printer, thus increasing the cost and failure rate of the printer. Accordingly, it would be desirable to be able to implement a dynamic, corrective adjustment of a scanned image (e.g., due to a misalignment of an installed image sensor and/or an document fed in to the machine at a skewed angle) in a manner that does not result in added mechanical components.

### SUMMARY

The foregoing discussed drawbacks and deficiencies of the prior art are overcome or alleviated by a method for dynamically adjusting alignment of a scanned image. In an exemplary embodiment, the method includes generating a raw scanned calibration image, processing the raw scanned calibration image so as to determine a correction for each horizontal pixel of the image, and applying the determined correction to the entire scanned image so as to produce an aligned image.

In another embodiment, a storage medium includes a machine readable computer program code for dynamically adjusting alignment of a scanned image, and instructions for causing a computer to implement a method. The method further includes generating a raw scanned calibration image, processing the raw scanned calibration image so as to determine a correction for each horizontal pixel of the image, and applying the determined correction to the entire scanned image so as to produce an aligned image.

In still another embodiment, an image scanning apparatus includes an image sensor configured to generate a raw scanned calibration image of a scanned document, and a correction algorithm configured to process the raw scanned calibration image so as to determine a correction for each horizontal pixel of the image. The correction algorithm is further configured to apply the determined correction to the entire scanned image so as to produce an aligned image.

### TECHNICAL EFFECTS

As a result of the above summarized invention, a solution is technically achieved which results in improved image scanning and printing, and in a dynamic manner that reduces the amount of mechanical components in a device, thereby also realizing a cost savings.

### BRIEF DESCRIPTION OF THE DRAWINGS

Referring to the exemplary drawings wherein like elements are numbered alike in the several Figures:

FIG. 1 is a schematic diagram of an exemplary scanning/printing device suitable for use in accordance with an embodiment of the invention; and

FIG. 2 is a process flow diagram illustrating a method for dynamically adjusting the alignment of an image scanned into a printing device, as implemented by the algorithm of FIG. 1.

### DETAILED DESCRIPTION

Disclosed herein is a method and apparatus for dynamically adjusting the alignment of an image scanned into a printing device. Briefly stated, a correction algorithm is applied to a scanned, raw calibration image (such as a horizontal line or document border) so as to generate a corrected calibration image. The specific alignment processing used to produce to the corrected calibration image is then applied to pixels of the entire document to produce a corrected image, thereby providing dynamic adjustment depending upon the original relationship between the scanned document and the image sensor. It is understood that the disclosed embodiments equally apply to a device that scans a document to create an image file rather than printing the document.

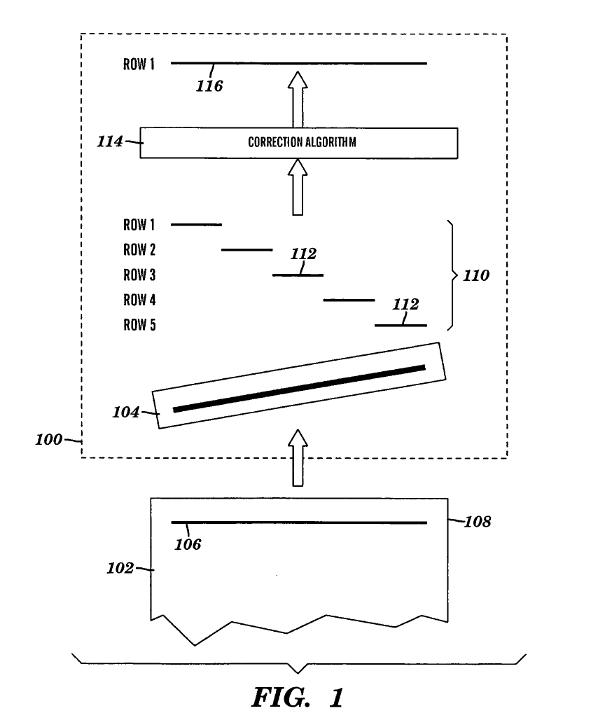

Referring initially to FIG. 1, there is shown a schematic diagram of an exemplary scanning/printing device 100 suitable for use in accordance with an embodiment of the invention. The device 100 may represent, for example, a POS printer or any other device having image scanning/printing capability such as a copier, for example. As is shown, a document 102 is fed into the device 100, which includes an image scanner 104 therein. In an exemplary embodiment, the image scanner 104 is a linear image sensor that is shown misaligned with respect to a nominal feed path for purposes of illustration. However, it should be understood that the image correction methodology described herein would be equally applicable where the image scanner 104 were properly aligned with a nominal document feed path.

In either case, the image sensor 104 captures a raw image of a horizontal calibration line 106 included on the document 102. Alternatively, other features of the document (such as the leading edge 108 thereof) could also be used for calibration purposes in the event the document 102 does not have a suitable horizontally printed feature thereon. Regardless of whether the misalignment is due to the position of the sensor 104, the angle at which the document 102 is fed into the device 100, or a combination of both, a raw calibration image 110 is produced. As is also exaggerated for purposes of illustration, the scanned raw image 110 is seen as a horizontal “stair-stepped” image of several line segments 112. In reality, the distance between rows in an actual document would be smaller than is shown in FIG. 1.

Depending upon the length of the calibration line segments 112 in a given document row, a correction algorithm 114 implemented by a processing portion of the scanning/printing device 100 provides appropriate row adjustments for a given pixel column of the document so as to produce a corrected calibration image 116. The adjustments used for the pixels of the scanned calibration line are applied to the entire scanned image of the document 102 so as to provide dynamic image correction.

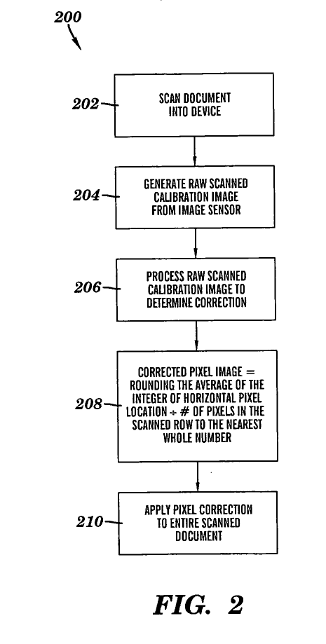

Referring now to FIG. 2, there is shown a process flow diagram illustrating a method 200 for dynamically adjusting the alignment of an image scanned into a printing device, as implemented by the algorithm 114 of FIG. 1. As shown in blocks 202, 204 and 206, the document 102 is scanned into the device 100, upon which a raw scanned image 110 is generated by the image sensor 104. The raw scanned image 110 is processed by the algorithm 114 to determine the degree of correction to be applied to the pixels of the entire scanned image. As specifically illustrated in block 208, the algorithm 114 determines the following corrective adjustment for a pixel image by rounding the average of the integer functions of (each horizontal pixel location÷the number of pixels in the scanned row) to the nearest whole number.

In this instance, the horizontal location of a pixel represents the column number of the pixel with respect to the document. For example, if there are 256 pixel columns in a document, then the horizontal location numbers of the pixels range from 0 (leftmost pixel) to 255 (rightmost pixel). Thus, for each pixel number 0-255 for a document, the algorithm 114 (based on the nature of the raw scanned calibration image) will determine an appropriate row adjustment for that pixel to produce the final image. Once determined, the pixel row correction is applied to the entire document to produce a corrected image as shown in block 210.

Referring once again to FIG. 1, it will be assumed (for example purposes only) that the portion of scanned raw calibration image 110 in Row 1 occupies pixel locations 0-51 (a total of 52 pixels), the raw calibration image in Row 2 occupies pixel locations 52-100 (a total of 49 pixels), the raw calibration image in Row 3 occupies pixel locations 101-154 (a total of 54 pixels), the raw calibration image in Row 4 occupies pixel locations 155-201 (a total of 47 pixels), and the raw calibration image in Row 5 occupies pixel locations 202-255 (a total of 54 pixels).

Applying the above formula from block 208 in FIG. 2 to the pixels of Row 1, it will be seen that for each of the pixel locations 0-51, the integer of that number divided by 52 (the total number of pixels in Row 1) yields a decimal number less than 1 in each instance, the integer of which is 0 and thus the average of all the integers in row 1 is 0. Therefore, there is a row adjustment of 0 for pixel locations 0-50.

For those pixels in Row 2 (i.e., locations 52-100), it is seen that the integer function of the numbers 52 through 97 (when divided by 49) each yield a number greater than 1 but less than 2, resulting in an integer of 1, while this function for each of pixels 98, 99 and 100 yields integers of 2. The sum of the integers for the pixel locations in Row 2 is (46×1)+(3×2)=52. The average of the integers for Row 2 yields 52/49=1.06, which when rounded to the nearest whole number results in an adjustment of 1. Therefore, every pixel that printed in Row 2 will be adjusted (upward in this case) by 1 row.

Proceeding to Row 3, it will be seen that the first pixel locations in that row (101 through 107) yield a decimal number less than 2 when divided by 54, giving an integer of 1. On the other hand, pixels 108 through 154 have a decimal equal to or greater than 2 but less than 3, giving an integer of 2. Averaging the integers for Row 3 gives 1.87 (101/54=1.87), when rounded to the nearest whole number results in an adjustment of 2. Therefore, beginning at pixel location 101, there will now be a row shift of 2 rows for the corrected image.

Continuing the process for the remaining horizontal pixel locations in this example, each pixel in Row 4 (155-201) receives a shift of 3 rows in the corrected image. Here, pixels 155 through 187 have an integer of 3 and pixels 188 through 201 have an integer of 4. An average of these integers gives 3.3 (155/47=3.3) and, when rounded, gives an adjustment of 3. Finally, for Row 5, pixel locations 202 through 215 have an integer of 3 and pixels 216 through 254 have an integer of 4. Averaging these integers gives 3.7 (202/54=3.7), when rounded to the nearest whole number, gives an adjustment for Row 5 of 4 rows. This rounding of integer averages is one mathematical way of determining the “dominant” integer of a given row, thereby determining the correct row adjustment for the pixels in that row. Other similar mathematical manipulations may also be used to make this determination.

In the example above, the corrected image is normalized to Row 1 of the document (i.e., the pixels in Row 2 of the raw image are shifted up by 1 row in the corrected image, the pixels in Row 3 of the raw image are shifted up by 2 rows, etc.). However, in the event the misalignment of the calibration line were sloped in the opposite direction (i.e., the leftmost pixels of the raw image appear in Row 5 and the rightmost pixels of the raw image appear in Row 1), the algorithm may apply a positive or negative sign to the integer function to determine whether the row adjustment is upward or downward.

Thus, in an opposite case where the leftmost pixels do not appear in the first row of the scanned image, the corrected image can be normalized to the row in which the leftmost pixels do appear (e.g., Row 5), and the subsequent pixels to the right are now adjusted downward by one or more rows instead of upward.

In view of the above, the present method embodiments may therefore take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described- above and illustrated in FIG. 2.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for dynamically adjusting alignment of a scanned image, the method comprising:
generating a raw scanned calibration image;
processing said raw scanned calibration image so as to determine a correction for each horizontal pixel of the image; and
applying said determined correction to the entire scanned image so as to produce an aligned image.

2. The method of claim 1, wherein said processing said raw scanned calibration image further comprises determining a row adjustment to be applied of each of said horizontal pixel locations.

3. The method of claim 2, wherein said correction for a given pixel is a function of said horizontal pixel location and the number of pixels in a row for each row containing said raw scanned calibration image.

4. The method of claim 3, wherein said correction for a given pixel comprises a row correction determined by rounding, to the nearest whole number, the average of the integer function of: said horizontal pixel location divided by said number of pixels in a row for each row containing said raw scanned calibration image.

5. The method of claim 4, wherein said correction comprises one of a positive row correction or a negative row correction, depending upon the presence or absence of said raw scanned image in a leftmost group of pixels in a first row thereof.

6. The method of claim 1, wherein said raw scanned calibration image comprises a printed horizontal line on a scanned document.

7. The method of claim 1, wherein said raw scanned calibration image comprises a leading horizontal edge of a scanned document.

8. A storage medium, comprising:
a machine readable computer program code for dynamically adjusting alignment of a scanned image; and
instructions for causing a computer to implement a method, the method further comprising:
generating a raw scanned calibration image;
processing said raw scanned calibration image so as to determine a correction for each horizontal pixel of the image; and
applying said determined correction to the entire scanned image so as to produce an aligned image.

9. The storage medium of claim 8, wherein said processing said raw scanned calibration image further comprises determining a row adjustment to be applied of each of said horizontal pixel locations.

10. The storage medium of claim 9, wherein said correction for a given pixel is a function of said horizontal pixel location and the number of pixels in a row for each row containing said raw scanned calibration image.

11. The storage medium of claim 10, wherein said correction for a given pixel comprises a row correction determined by rounding, to the nearest whole number, the average of the integer function of: said horizontal pixel location divided by said number of pixels in a row for each row containing said raw scanned calibration image.

12. The storage medium of claim 11, wherein said correction comprises one of a positive row correction or a negative row correction, depending upon the presence or absence of said raw scanned image in a leftmost group of pixels in a first row thereof.

13. The storage medium of claim 8, wherein said raw scanned calibration image comprises a printed horizontal line on a scanned document.

14. The storage medium of claim 8, wherein said raw scanned calibration image comprises a leading horizontal edge of a scanned document.

15. An image scanning apparatus, comprising:
an image sensor configured to generate a raw scanned calibration image of a scanned document; and
a correction algorithm configured to process said raw scanned calibration image so as to determine a correction for each horizontal pixel of the image; and
said correction algorithm further configured to apply said determined correction to the entire scanned image so as to produce an aligned image.

16. The apparatus of claim 15, wherein said processing said raw scanned calibration image further comprises determining a row adjustment to be applied of each of said horizontal pixel locations.

17. The apparatus of claim 16, wherein said correction for a given pixel is a function of said horizontal pixel location and the number of pixels in a row for each row containing said raw scanned calibration image.

18. The apparatus of claim 17, wherein said correction for a given pixel comprises a row correction determined by rounding, to the nearest whole number, the average of the integer function of: said horizontal pixel location divided by said number of pixels in a row for each row containing said raw scanned calibration image.

19. The apparatus of claim 18, wherein said correction comprises one of a positive row correction or a negative row correction, depending upon the presence or absence of said raw scanned image in a leftmost group of pixels in a first row thereof.

20. The apparatus of claim 15, wherein said raw scanned calibration image comprises one of: a printed horizontal line on a scanned document and a leading horizontal edge of a scanned document.
